(19) United States
(12) Patent Application Publication
(10) Pub. No.: US 2011/0264452 A1
(43) Pub. Date: Oct. 27, 2011

(54) AUDIO OUTPUT OF TEXT DATA USING SPEECH CONTROL COMMANDS

(76) Inventors: Ramya Venkataramu, Campbell, CA (US); Molly Joy, San Jose, CA (US)

(21) Appl. No.: 12/768,634

(22) Filed: Apr. 27, 2010

(51) Int. Cl. G10L 13/00

(52) U.S. Cl. 704/260; 704/E13.001

(57) ABSTRACT

Example embodiments disclosed herein relate to audio output of speech data using speech control commands. In particular, example embodiments include a mechanism for accessing text data. Example embodiments may also include a mechanism for outputting the text data as audio by converting the text data to speech audio data and transmitting the speech audio data over an audio output. Example embodiments may also include a mechanism for receiving speech control commands that allow for voice control of the output of the audio data.

### BACKGROUND

Given the sheer amount of information on the World Wide Web and the ease with which this information can be obtained, many people now eschew traditional research methods and rely exclusively on the web for obtaining information. With the breadth of data available, a user can instantly access helpful information on just about any topic of interest. For example, a user may quickly and easily obtain a dinner recipe, instructions for a home improvement project or car repair, and tips for improving a golf swing.

To provide instant access to this information regardless of their physical location, many users own multiple computing devices, each designed for a different use scenario. For example, a user may own a desktop computer for his or her home office, a small touch screen computer for the kitchen, and a mobile computing device, such as a cell phone or slate computer, for accessing data away from home. Unfortunately, despite the massive amount of information available and countless devices for providing access, current access methods often constrain the manner in which users can consume the information.

### BRIEF DESCRIPTION OF THE DRAWINGS

In the accompanying drawings, like numerals refer to like components or blocks. The following detailed description references the drawings, wherein:

FIG. 1 is a block diagram of an example computing device for auditorily outputting text data based on speech control commands;

FIG. 2 is a block diagram of an example computing device for auditorily outputting text data based on receipt of two types of speech control commands;

FIG. 3 is a flowchart of an example method for controlling speech output of text data;

FIG. 4A is a flowchart of an example method for speech output of text data using step-by-step control commands;

FIG. 4B is a flowchart of an example method for speech output of text data using continuous control commands;

FIG. 5A is a block diagram of an example operation flow by which a user controls speech output of text data using step-by-step control commands; and

FIG. 5B is a block diagram of an example operation flow by which a user controls speech output of text data using continuous control commands.

### DETAILED DESCRIPTION

Existing data access methods generally require users to read electronically-stored information from a display device or from a printed hard copy. Such access methods make it difficult for the user to utilize electronic information, particularly when he or she is using the information to simultaneously accomplish a task that requires his or her attention. Thus, as described below, example embodiments relate to audio output of text data using speech control commands.

In particular, in some embodiments, a computing device may include instructions for accessing text data and instructions for auditorily outputting the text data by converting the text data to speech audio data and transmitting the speech audio data over an audio output. In addition, to allow for user control of the outputted audio data, the computing device may also include instructions for receiving speech control commands via a voice input interface. In this manner, a user may control audio output of text data even when located at a distance from the computing device. Additional embodiments and applications of such embodiments will be apparent to those of skill in the art upon reading and understanding the following description.

In the description that follows, reference is made to the term, “machine-readable storage medium.” As used herein, the term “machine-readable storage medium” refers to any electronic, magnetic, optical, or other physical storage device that contains or stores executable instructions or other data (e.g., a hard disk drive, flash memory, etc.).

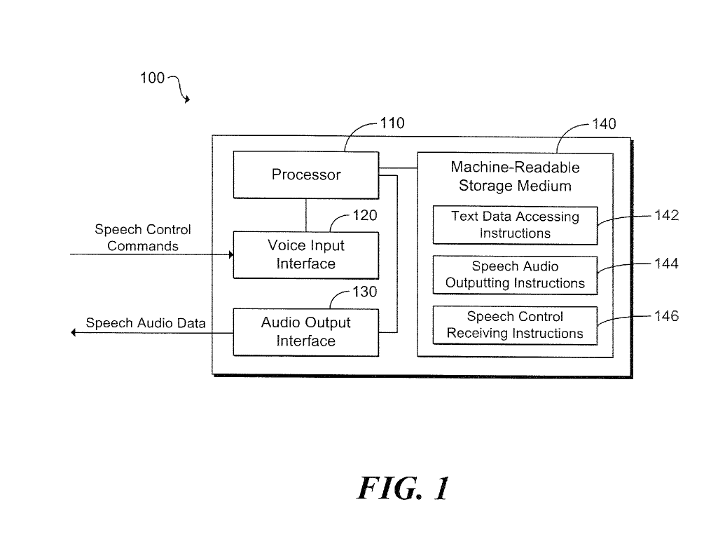

Referring now to the drawings, FIG. 1 is a block diagram of an example computing device 100 for auditorily outputting text data based on speech control commands. Computing device 100 may be, for example, a desktop computer, a laptop computer, a touch screen computer, a handheld or slate computing device, a mobile phone, or the like. In the embodiment of FIG. 1, computing device 100 includes processor 110, voice input interface 120, audio output interface 130, and machine-readable storage medium 140.

Processor 110 may be a central processing unit (CPU), a semiconductor-based microprocessor, or any other hardware device suitable for retrieval and execution of instructions stored in machine-readable storage medium 140. In particular, processor 110 may fetch, decode, and execute instructions 142, 144, 146 to implement the functionality described in detail below.

Voice input interface 120 may be a hardware device that receives audio from a source external to computing device 100, such as a user. For example, voice input interface 120 may be a wireless host in communication with a wireless headset, such that voice input interface 120 receives a stream of a user's speech captured by the headset, provided that the user remains within the effective range of the headset. In such implementations, voice input interface 120 may be a Bluetooth® host in communication with a Bluetooth® headset. As another example, voice input interface 120 may be a microphone embedded in computing device 100 or an external microphone coupled to a line-in of computing device 100. Other suitable devices for receipt of audio data will be apparent to those of skill in the art. Regardless of the particular implementation, voice input interface 120 may receive speech control commands from a user and provide them to speech control receiving instructions 146 via processor 110. In this manner, a user may provide voice commands to interface 120 to control the playback of text data.

Audio output interface 130 may be a hardware device that outputs audio based on receipt of instructions from processor 110. Thus, audio output interface 130 may be a sound card or onboard audio device that processes analog or digital signals for transmission over a particular output. For example, audio output interface 130 may be coupled to an internal or external speaker, headphones, or a headset. As another example, audio output interface 130 may be a Bluetooth or other wireless host that transmits an output signal to a headset. Regardless of the particular implementation, audio output interface 130 may receive speech audio from processor 110 via speech audio outputting instructions 144 and auditorily output the speech to the user.

Machine-readable storage medium 140 may be encoded with executable instructions for effecting audio output of text data based on receipt of speech control commands. These executable instructions may be, for example, a portion of an operating system (OS) of computing device 100 or a separate application running on top of the OS. As another example, the executable instructions may be implemented in web-based script (e.g., JavaScript) interpretable by a web browser executing on computing device 100. Other suitable formats of the executable instructions will be apparent to those of skill in the art.

Machine-readable storage medium 140 may include text data accessing instructions 142, which may retrieve text data from a location accessible to computing device 100. For example, text data accessing instructions 142 may retrieve the text data from a local file location (e.g., a hard drive or flash memory drive) or from a remote file location (e.g., a network drive or a web page). The text data retrieved by accessing instructions 142 may be in any of a number of formats, provided that the data includes readable text. For example, the text data may be a portion of a Portable Document Format (PDF) file, a word processing document, a plain text file, a Hypertext Markup Language (HTML) document, or a file in a proprietary format. The text data may also be included in an image file, provided that text data accessing instructions 142 are capable of performing an optical character recognition (OCR) process on the image file. Furthermore, the text data may be written in any language, provided that speech audio outputting instructions 144 include appropriate code for converting text to speech for that language.

Machine-readable storage medium 140 may also include speech audio outputting instructions 144, which may convert the text data to speech audio data and transmit the speech audio data to audio output interface 130 for playback to the user. As detailed below in connection with speech control receiving instructions 146, outputting instructions 144 may convert and output the speech data in accordance with speech commands provided by the user. In particular, upon receiving an indication to start, stop, or otherwise control playback of the text data, speech control receiving instructions 146 may provide this indication to speech audio outputting instructions 144.

Audio outputting instructions 144 may include instructions for simulating human speech using the text included in the text data. Upon receipt of an appropriate command from speech control receiving instructions 146, audio outputting instructions 144 may begin execution. Outputting instructions 144 may include, for example, text-to-phoneme instructions that assign phonetic transcriptions to each word and divide the text into prosodic units for a particular language. Outputting instructions 144 may then perform linguistic analysis to generate phasing, intonation, and duration information. Finally, outputting instructions 144 may transmit a waveform containing the simulated speech over audio output interface 130 via processor 110. Suitable instructions for implementing each phase of the text-to-speech conversion will be apparent to those of skill in the art.

In some embodiments, outputting instructions 144 may convert the text data to speech audio data using a commercially available software package. For example, when computing device 100 is executing the Microsoft Windows® operating system, speech audio outputting instructions 144 may include function calls to the Microsoft Speech Application Program Interface (SAPI). In such implementations, speech audio outputting instructions 144 may first create an ISpVoice object, specify a voice to be used for the object, then trigger output of speech using the “Speak” function of the ISpVoice object. Other suitable APIs and software packages for generation of speech will be apparent to those of skill in the art.

Finally, machine-readable storage medium 140 may include speech control receiving instructions 146 that receive and process speech control commands via voice input interface 120. In particular, speech control receiving instructions 146 may receive and process an analog waveform from voice input interface 120 to recognize speech from the user and, more specifically, recognize the use of a particular word from a predefined group of commands.

Speech control receiving instructions 146 may comprise, instructions that receive an analog waveform and translate the waveform into digital data using a predefined sampling rate. Receiving instructions 146 may then divide the digital data into small segments and, for each of these segments, attempt to identify phonemes in the appropriate language. Finally, receiving instructions 146 may analyze the phonemes in groups to identify particular words. When a particular word is detected that corresponds to a command in the predetermined group of commands, speech control receiving instructions 146 may notify speech audio outputting instructions 144, such that the output of the audio data may be controlled accordingly.

As with outputting instructions 144, speech control receiving instructions 146 may, in some embodiments, utilize a commercially available software package. For example, when computing device 100 is running Microsoft Windows®, speech control receiving instructions 146 may utilize the Microsoft SARI Recognition Device Driver Interface (DDI). In such implementations, receiving instructions 146 may access an engine, known as the ISpSREngine, to recognize speech control commands in a stream received via voice input interface 120. In particular, receiving instructions 146 may call the RecognizeStream function of the ISpSREngine and, in some embodiments, may pass the function a predefined set of candidates (e.g., a predefined list of commands). In response, the DDI engine may provide text of any detected commands in the audio stream. Other suitable APIs and software packages for speech recognition will be apparent to those of skill in the art.

In some embodiments, speech control receiving instructions 146 may be configured to recognize words from a small, predefined vocabulary. For example, in implementations in which only a step-by-step command method is supported, the vocabulary may include only “beginning,” “move,” and “back.” Such implementations increase the accuracy of the voice engine by avoiding the potential for false positives.

Furthermore, in some embodiments, the commands included in the vocabulary may be selected based on the characteristics of the particular voice input interface 120. For example, when the voice input interface 120 is a wireless host coupled to a wireless headset, the sampling rate of the headset may be relatively low. In such implementations, the commands may be preselected based on a testing procedure. As an example, a developer may determine a set of synonyms for each speech command to be included, then test the accuracy of each synonym to select a group of synonyms that are best suited for the particular interface.

In operation, computing device 100 may execute text data accessing instructions 142 to retrieve text data for output over audio output interface 130. More specifically, computing device 100 may execute speech control receiving instructions 146 to await receipt of a control command from the user via voice input interface 120. Upon receipt of such a command, receiving instructions 146 may notify speech audio outputting instructions 144 for conversion and output of an appropriate portion of the text data over audio output interface 130.

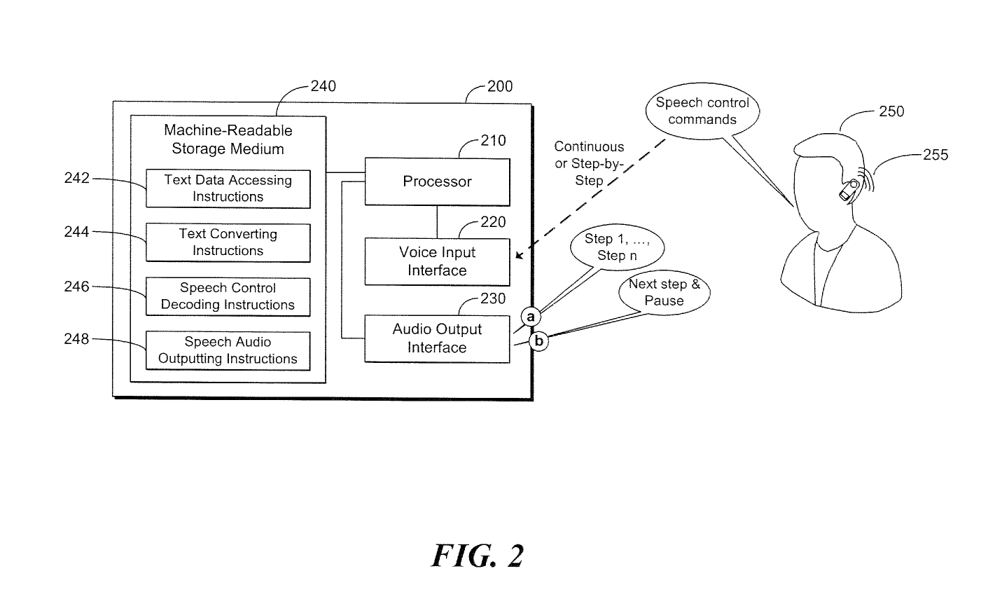

FIG. 2 is a block diagram of an example computing device 200 for auditorily outputting text data based on receipt of two types of speech control commands. As with computing device 100 of FIG. 1, computing device 200 may be for example, a desktop computer, a laptop computer, a touch screen computer, a handheld or slate computing device, a mobile phone, or the like. In the embodiment of FIG. 2, computing device 200 includes processor 210, voice input interface 220, audio output interface 230, and machine-readable storage medium 240.

As with processor 110, processor 210 of computing device 200 may be a central processing unit (CPU), a semiconductor-based microprocessor, or any other hardware device suitable for retrieval and execution of instructions stored in machine-readable storage medium 240. In particular, processor 210 may fetch, decode, and execute instructions 242, 244, 246, 248 to implement the functionality described in detail below.

As with voice input interface 120, voice input interface 220 of computing device 200 may be any hardware device that receives audio from a source external to computing device 200. Thus, voice input interface 220 may be, for example, a wireless host in communication with a wireless headset, a microphone embedded in computing device 200, an external microphone coupled to a line-in of computing device 200, or any other hardware device suitable for receipt of audio data. As described in detail below, voice input interface 220 may receive speech control commands from a user 250, then forward the commands to speech control decoding instructions 246 for processing.

As with audio output interface 130, audio output interface 230 of computing device 200 may be any hardware device that outputs audio based on receipt of instructions from processor 210. Thus, audio output interface 230 may be an analog or digital sound card, a wireless host that transmits an output signal to a headset, or any other hardware device suitable for output of audio. As described in detail below, audio output interface 230 may receive speech audio from processor 210 via speech audio outputting instructions 248 and, in response, may output the speech to the user 250.

Machine-readable storage medium 240 may be encoded with executable instructions for effecting audio output of text data based on receipt of speech control commands from user 250. In particular, storage medium 240 may include text data accessing instructions 242, text converting instructions 244, speech control decoding instructions 246, and speech audio outputting instructions 248. Each of these sets of instructions is described in turn below.

Text data accessing instructions 242 may function similarly to text data accessing instructions 142 of computing device 100. Thus, text data accessing instructions 242 may retrieve text data from a local file location or a remote file location in any of a number of possible formats and languages. In some embodiments, the text data accessed by instructions 242 may be in the form of a set of directions for accomplishing a task, with the set of directions including a plurality of steps. To name a few examples, the set of directions may be a recipe, instructions for a home improvement project or assembling furniture, driving directions, or any other set of information for accomplishing a particular task. When the set of directions is a recipe, each step included in the directions may be either an ingredient included in the recipe or a given step in following the recipe.

Text converting instructions 244 may receive the text data from accessing instructions 242 and convert the text data to speech audio data that contains a computer-generated reading of the text data. In particular, as described above in connection with speech audio outputting instructions 144, text converting instructions 244 may convert the next portion of text data to a series of phonemes, perform linguistic analysis on the phonemes, and generate a waveform containing the simulated speech. In some embodiments, text converting instructions 244 may generate the waveform using a commercially available software package or API. In embodiments in which the text data is a set of directions, text converting instructions 244 may generate the speech audio data for each step included in the directions. As described below, after generation of the waveform, speech audio outputting instructions 248 may output the audio based on receipt of speech control commands from the user 250.

In some embodiments, in order to identify the portions of the text data to be converted to speech audio data, instructions 244 may include instructions for parsing the text data into portions. For example, when the text data is a set of directions, instructions 244 may first divide the text data into a plurality of steps. As one example, the parsing may be executed using an ordering scheme included in the text that marks the sequence of steps, such as a predefined numbering or lettering scheme. As another example, user 250 may manually identify the portions or steps within the text data using mouse clicks or key entries. As yet another example, instructions 244 may automatically parse the text data based on delimiting characters or sequences of characters, such as enter characters, tab characters, semicolons, commas, white space, and the like.

Speech control decoding instructions 246 may receive an input waveform from voice input interface 220 and, in response, decode the waveform to extract speech control commands. In particular, as with speech control receiving instructions 146, speech control decoding instructions 246 may execute an algorithm to divide the waveform into small segments, identify phonemes within the segments, and analyze the phonemes to identify particular words. When a particular word is detected that corresponds to a command in the set of speech control commands, speech control decoding instructions 246 may notify speech audio outputting instructions 248, such that output of the text data may be controlled accordingly. In embodiments in which the text data is a set of directions, the speech control commands provided by user 250 may be used to direct sequential output of each step in the directions.

In some embodiments, the speech control commands may include one or more sets of commands, each of which control a different reading method. In particular, the speech control commands may include a first set of control command that allow for continuous reading, such that, after reading begins, it continues until the user 250 directs the system otherwise. The commands for the continuous read method may therefore include a command for beginning speech output of the text data in sequential order, a command for pausing speech output, and a command for resuming speech output after a pause command is issued.

In some embodiments, the specific commands utilized for continuous reading may be optimized for the particular voice input interface 220. For example, some embodiments may utilize “again” to start playback, “discontinue” to pause playback, and “move” to resume playback after issuing a pause command. Such commands are particularly useful when voice input interface 220 is a Bluetooth® host in communication with a Bluetooth® headset 255, as the rate of false positives and detection failures is particularly low for this group of commands. Furthermore, detection is accurate with these commands, even in devices that have low sampling rates, such as Bluetooth® headsets.

The speech control commands may, in addition or as an alternative, include a second set of control commands that allow for step-by-step reading, such that only one step of the text data is read at a time. The commands for step-by-step reading may therefore include a command for starting speech output of only the first step in the text data. In addition, the commands for step-by-step reading may include a command for starting speech output of a next step in the text data and a command for repeating speech output of a last-outputted step.

As with the continuous reading method, in some embodiments, the specific commands utilized for step-by-step reading may be optimized for the particular voice input interface 220. For example, some embodiments may utilize “beginning” to start playback, “move” to continue with the next step, and “back” to repeat the last step. Such a combination of commands is particularly useful when voice input interface 220 is a Bluetooth® host in communication with a Bluetooth® headset 255, as the rate of false positives and detection failures is particularly low for this group of commands.

Speech audio outputting instructions 248 may receive speech audio data from text converting instructions 244 and output the audio data via audio output interface 230 in accordance with speech control commands detected by speech control decoding instructions 246. In particular, upon receipt of an instruction to start continuous playback, speech audio outputting instructions 248 may begin outputting the speech over audio output interface starting with the first step (see (a)). Similarly, upon receipt of an instruction to start step-by-step playback, speech audio outputting instructions 248 may output the first step and pause to await the next command from user 250 (see (b)). Output of the remaining steps of the text data may then be controlled in accordance with any additional user commands detected by speech control decoding instructions 246.

As illustrated, user 250 may issue speech control commands via a wireless headset 255, such as a Bluetooth® headset. User 250 may control the playback of the text data in accordance with the speech control commands described in detail above in connection with speech control decoding instructions 246 and speech audio outputting instructions 248.

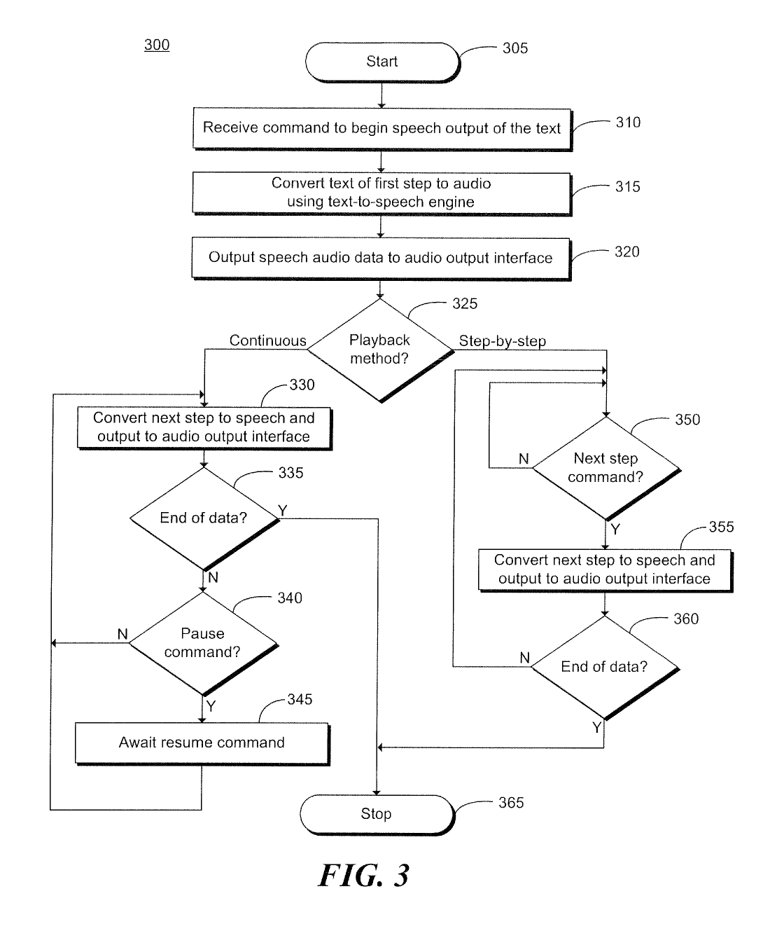

FIG. 3 is a flowchart of an example method 300 for controlling speech output of text data. Although execution of method 300 is described below with reference to the components of computing device 100, other suitable components for execution of method 300 will be apparent to those of skill in the art. Method 300 may be implemented in the form of executable instructions stored on a machine-readable storage medium, such as machine-readable storage medium 140 of computing device 100 or machine-readable storage medium 240 of computing device 200.

Method 300 may start in block 305 and proceed to block 310, where computing device 100 may receive a voice command indicating that the user desires to begin speech output of the data. In particular, computing device 100 may receive, via a voice input interface, a voice command for beginning speech output of a first step of a particular set of text data. In some embodiments, this text data may contain a set of directions for accomplishing a task. For example, the text data may be a recipe, directions for assembling furniture, steps in shooting a basketball, or any other set of steps for accomplishing a task. It should be noted, however, that method 300 may be applied to any text data containing any content (e.g., an audio book, a news article, etc.). Thus, as used herein, the term “step” may refer to any portion of text data (e.g., a sentence, paragraph, etc.).

In addition, in some embodiments, the command provided by the user may correspond to a particular method for outputting the text data. For example, a first command (e.g., “beginning”) may direct computing device 100 to start outputting the text data starting with a first step using a step-by-step method, while a second command (e.g., “again”) may direct computing device 100 to use a continuous playback method. The use of the received voice command in determining and executing a particular playback method is described in further detail below in connection with block 325.

After receipt of a command to begin speech output of the text, method 300 may proceed to block 315, where computing device 100 may convert the text of a first step in the text data to speech audio data. In particular, computing device 100 may execute a text-to-speech algorithm to generate analog or digital data capable of output via an audio interface. Examples of such algorithms are described in detail above in connection with speech audio outputting instructions 144 of FIG. 1.

Method 300 may then proceed to block 320, where computing device 100 may output the speech audio data to an audio output interface. For example, computing device 100 may route the analog or digital audio data generated in block 315 to an output port of a sound card or other audio output interface. The audio output interface may thereby play the audio data to the user using speakers, headphones, or the like.

After outputting the first step of the text data, method 300 may then proceed to block 325, where computing device 100 may determine whether the voice command received in block 310 corresponds to a continuous reading method or, alternatively, to a step-by-step reading method. When it is determined that the voice command specified the continuous reading method, method 300 may proceed to block 330.

Using the continuous reading method, computing device 100 may sequentially convert each step to speech audio data and output the speech audio data until computing device 100 receives a pause command or reaches the end of the text data. Thus, starting in block 330, computing device 100 may first convert the next step in the text data to speech data in a manner similar to block 315, described in detail above. Computing device 100 may then output the speech audio data for the next step to the audio output interface in a manner similar to block 320, also described in detail above.

After conversion and output of the next step, method 300 may then proceed to block 335, where computing device 100 may determine whether it has reached the end of the text data. If so, method 300 may proceed to block 365, where method 300 may stop. Alternatively, when it is determined that computing device 100 has not reached the end of the text data, method 300 may proceed to block 340.

In block 340, computing device 100 may determine whether a pause command has been received from the user. For example, computing device 100 may detect receipt of a pause command via a voice input interface, such as a wireless headset or an internal or external microphone. When it is determined that a pause command has been received, method 300 may proceed to block 345, where computing device 100 may await receipt of a resume command via the voice input interface. Upon receipt of the resume command in block 345, method 300 may return to block 330 for processing of the next step in the text data. When it is instead determined in block 340 that a pause command has not been received, method 300 may return to block 330, where computing device 100 may retrieve the next step in the text data, convert it to speech, and output the speech to the user. This process may continue until computing device 100 reaches the end of the text data.

Alternatively, when it is determined in block 325 that the voice command specified step-by-step reading, method 300 may proceed to block 350. Using the step-by-step reading method, computing device 100 may, after output of each step, await receipt of a voice command prior to resuming reading of the text data. Thus, in block 350, computing device 100 may determine whether a next step command has been received via the voice input interface. When it is determined that a next step command has been received, method 300 may continue to block 355, where computing device 100 may retrieve the next step, convert it to speech audio data, and output the speech audio data in a manner similar to blocks 315 and 320, described in detail above.

Method 300 may then proceed to block 360, where computing device 100 may determine whether it has reached the end of the text data. If so, method 300 may proceed to block 365, where method 300 may stop. Alternatively, when computing device 100 determines that it has not reached the end of the text data, method 300 may return to block 350 to await receipt of the next step command.

When it is determined in block 350 that a next step command has not been received, method 300 may continuously repeat block 350 until receipt of a next step command. In other words, computing device 100 may monitor for receipt of a next step command prior to proceeding to output the next step in the text data. The step-by-step reading method thereby allows for output of one step at a time, such that the user may control playback at his or her own pace. It should be noted that, in some embodiments, if no command is issued, a timeout may be set to automatically issue the next command.

As described above, method 300 provides for control of audio output of the text data using two possible methods. In embodiments in which the user utilizes a wireless headset or a microphone coupled to computing device 100, such embodiments enable a user to control dictation of the set of directions for accomplishing the task in a hands-free manner. In particular, the user may easily carry out each step while controlling playback of the directions.

In embodiments in which the text data is a recipe, a user may easily follow the recipe without the need to touch the computing device 100. Such embodiments are useful, as the user may be located at a distance from his or her computing device and may dirty his or her hands during the cooking process. In these embodiments, the set of directions may include a number of steps, each of which is a particular ingredient or a particular task. The continuous reading method may thereby sequentially output speech audio data for all ingredients, followed by all tasks until receipt of a pause command. Another alternative for the continuous reading method is to issue a command to read out all the ingredients, followed by another command to have the system read out the preparation instructions. Alternatively, the step-by-step reading method may output one step at a time starting with a first ingredient in the listing of ingredients, proceeding through each ingredient, continuing with the first task in the list of tasks, and ending with a last task.

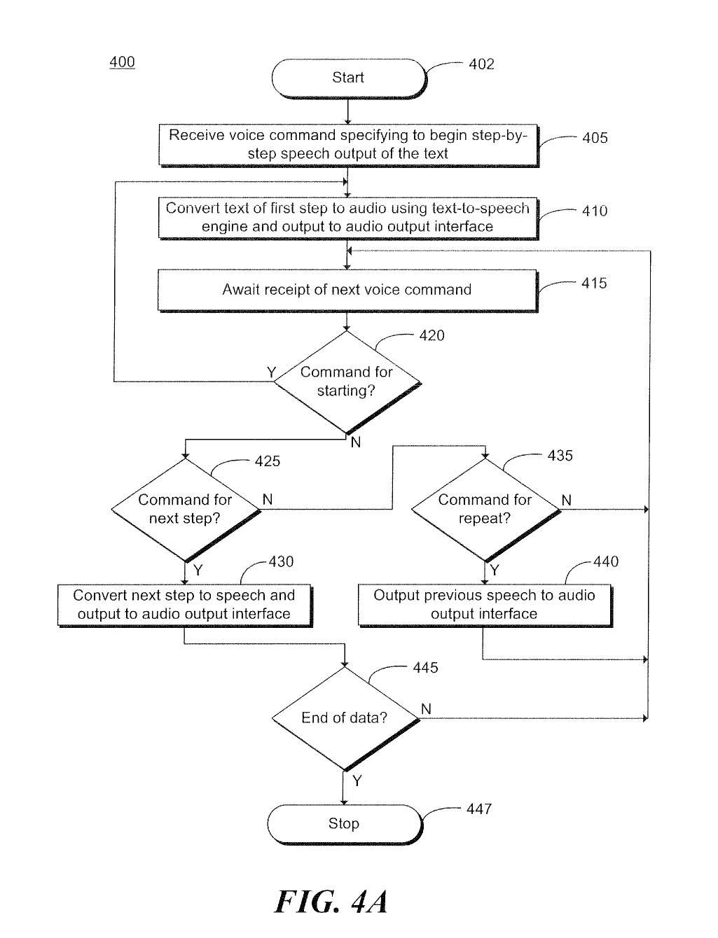

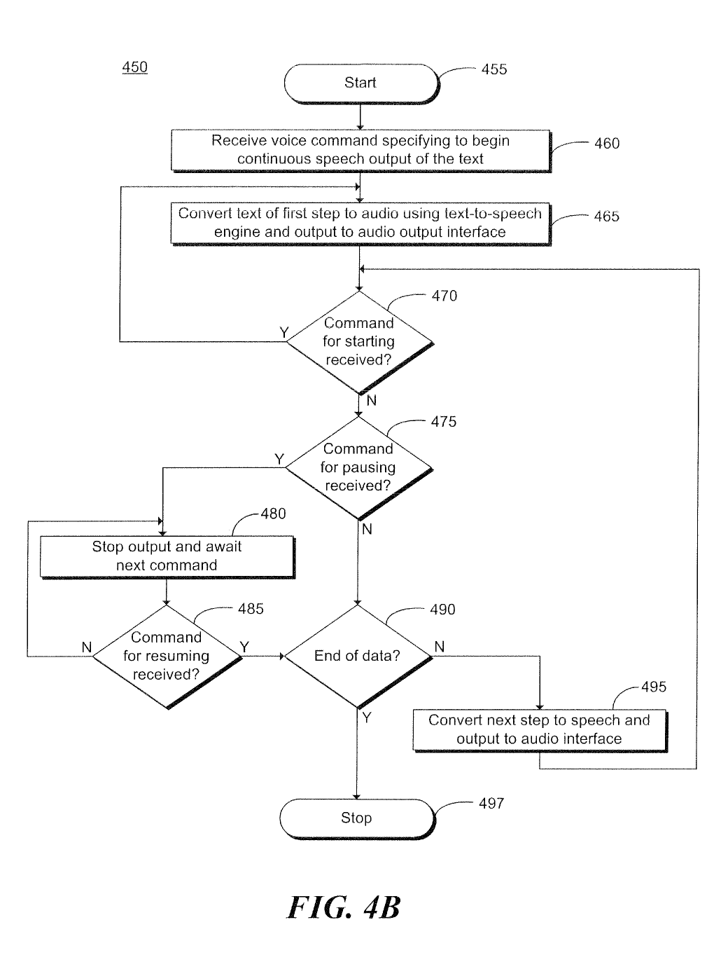

FIG. 4A is a flowchart of an example method 400 for speech output of text data using step-by-step control commands. Although execution of method 400 is described below with reference to the components of computing device 200, other suitable components for execution of method 400 will be apparent to those of skill in the art. Method 400 may be implemented in the form of executable instructions stored on a machine-readable storage medium, such as machine-readable storage medium 140 of computing device 100 or machine-readable storage medium 240 of computing device 200.

Method 400 may start in block 402 and proceed to block 405, where computing device 200 may receive a voice command to begin step-by-step speech output of the text data. The voice command for beginning step-by-step speech output may be any of a number of predetermined words or phrases, provided that these words and phrases may be distinguished from other commands. As one example, the command for starting step-by-step speech output may be “beginning.” Other suitable commands (e.g., “start,” “step-by-step,” etc.) will be apparent to those of skill in the art.

After receipt and detection of a particular voice command, method 400 may proceed to block 410, where computing device 200 may convert the text of the first step to speech audio data using an appropriate text-to-speech engine. For example, computing device 200 may utilize a commercially available software package or API, or, alternatively, execute a series of instructions for converting the text to speech. Additional implementation details for such a text-to-speech engine are provided in detail above in connection with text converting instructions 244 of computing device 200. After conversion of the text to speech audio data, computing device 200 may then output the corresponding speech audio data to the user using an audio output interface.

Method 400 may then proceed to block 415, where computing device 200 may await receipt of the next voice command. In particular, because the step-by-step method only outputs one step at a time, computing device 200 may await the next voice command prior to taking any additional action. Upon receipt of the next voice command that is properly recognized, method 400 may proceed to block 420.

In block 420, computing device 200 may first determine whether the recognized command is the command for starting output of the text data. When computing device 200 determines that the user has again provided the command for starting, method 400 may return to block 410 for conversion and output of the first step of the text data. Alternatively, when computing device 200 determines that the recognized command is not the command for starting output, method 400 may proceed to block 425.

In block 425, computing device 200 may determine whether the recognized command is the command for outputting the next step of the text data. As one example, the command for proceeding to the next step may be “move.” Other suitable commands for the next step (e.g., “next,” “proceed,” “continue,” etc.) will be apparent to those of skill in the art. When computing device 200 determines that the recognized command is the command for outputting the next step, method 400 may proceed to block 430. In block 430, computing device 200 may convert the next step to speech audio data and output the speech audio data to the audio output interface.

Method 400 may then continue to block 445, where computing device 200 may determine whether it has reached the end of the text data. When computing device 200 determines that it has reached the end of the text data, method 400 may proceed to block 447, where method 400 may stop. Alternatively, when computing device 200 determines that it has not reached the end of the text data, computing device 200 may return to block 415 to await receipt of the next voice command from the user.

Alternatively, when computing device 200 determines in block 425 that the recognized command is not the next step command, method 400 may proceed to block 435, where computing device 200 may determine whether the recognized command is the command to repeat the last-outputted step. If so, method 400 may proceed to block 440, where computing device 200 may retrieve the speech audio data for the last-outputted step (e.g., from random access memory) and output the speech audio data to the user. Method 400 may then return to block 415 to await receipt of the next voice command. Alternatively, when computing device 200 determines in block 435 that the voice command is not the repeat command, computing device 200 may determine that the command is not in the group of supported commands and therefore take no action prior to returning to block 415.

FIG. 4B is a flowchart of an example method 450 for speech output of text data using continuous control commands. Although execution of method 450 is described below with reference to the components of computing device 200, other suitable components for execution of method 450 will be apparent to those of skill in the art. Method 450 may be implemented in the form of executable instructions stored on a machine-readable storage medium, such as machine-readable storage medium 140 of computing device 100 or machine-readable storage medium 240 of computing device 200.

Method 450 may start in block 455 and proceed to block 460, where computing device 200 may receive a voice command to begin continuous speech output of the text data. The voice command for starting continuous speech output may be any of a number of predetermined words or phrases, provided that these words and phrases may be distinguished from other commands. As one example, the command for starting continuous speech output may be “again.” Other suitable commands (e.g., “start,” “first,” “continuous,” etc.) will be apparent to those of skill in the art.

After receipt and detection of a particular voice command, method 450 may proceed to block 465, where computing device 200 may convert the text of the first step to speech audio data using an appropriate text-to-speech engine. Computing device 200 may then output the corresponding speech audio data to the user using an audio output interface.

Method 450 may then proceed to block 470, where computing device 200 may begin monitoring for receipt of commands. In particular, in block 470, computing device 200 may determine whether it has received a user command for starting speech output of the text data. When computing device 200 determines that it has received a command for starting, method 450 may return to block 465 for conversion and output of the first step of the text data. Alternatively, when computing device 200 determines that it has not received a start command, method 400 may continue to block 475.

In block 475, computing device 200 may determine whether it has received a user command for pausing output of the text data. If so, method 450 may continue to block 480, where computing device 200 may stop playback and await receipt of the next command from the user. Upon receipt of a command, method 400 may continue to block 485, where computing device 200 may determine whether the received command is a resume command. If so, method 450 may continue to block 490, described in detail below. Alternatively, method 450 may return to block 480, where computing device 200 may continue to wait for receipt of the resume command from the user.

Returning to block 475, when computing device 200 determines that it has not received a command for pausing, method 450 may continue to block 490. In block 490, computing device 200 may determine whether it has reached the end of the text data (i.e., whether it has outputted all speech data to the user). If so, method 450 may proceed to block 497, where method 400 may stop. Alternatively, when computing device 200 determines that it has not yet reached the end of the text data, method 450 may continue to block 495, where computing device 200 may determine that it should continue outputting speech data to the user. Accordingly, computing device 200 may convert the next step in the text data to speech audio data and output the speech audio data to the user. Method 450 may then return to block 470, where computing device 200 may continue the speech output process.

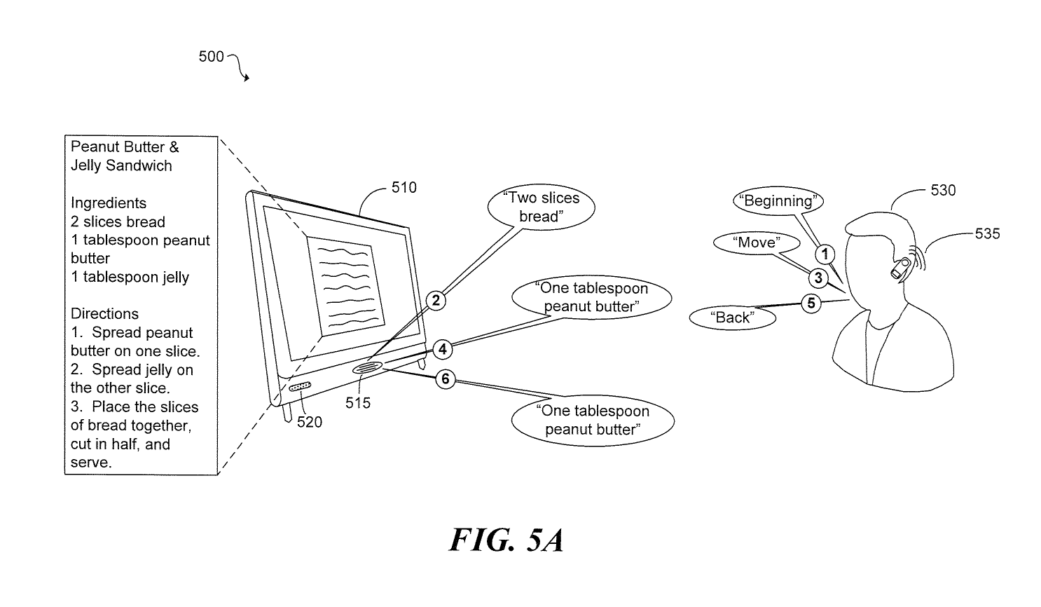

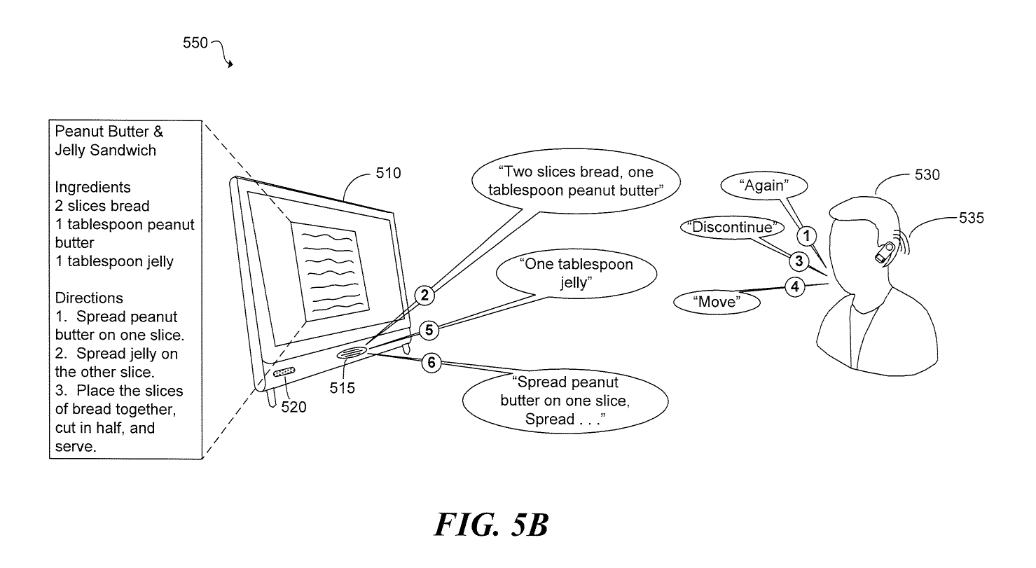

FIG. 5A is a block diagram of an example operation flow 500 by which a user 530 controls speech output of text data using step-by-step control commands. As illustrated, a user 530 utilizing a wireless headset 535 may provide voice commands to computing device 510, which may include an audio output interface 515 (here, a speaker) and a voice input interface 520 (here, a microphone). Furthermore, because the user 530 provides voice commands via a wireless headset 535, computing device 510 may also include a wireless host (not shown).

As described below, operation flow 500 relates to the use of an example set of step-by-step playback control commands provided via a wireless headset to trigger audio playback of a recipe. It should be apparent that the example operation flow 500 described below is equally applicable to other types of text data, sets of commands, voice input interfaces, and audio output interfaces.

As illustrated, in block 1 of operation flow 500, user 530 may initiate playback of a particular recipe by speaking the command, “beginning.” Upon detection and decoding of this command, computing device 510 may determine that user 530 desires step-by-step playback of the recipe currently in view. Accordingly, in block 2 of operation flow 500, computing device 510 may convert the first step (“Two slices of bread”) to speech audio data and output the audio data to user 530 via speaker 515. Because user 530 has indicated the desire to use the step-by-step reading method, computing device 510 may therefore pause and await receipt of the next voice control command.

In block 3 of operation flow 500, user 530 may dictate the “move” command to computing device 510 via wireless headset 535. Computing device 510 may detect and decode this command and, in response, determine that user 530 desires playback of the next step. Accordingly, in block 4, computing device 510 may retrieve the next step (“One tablespoon peanut butter”), convert it to speech audio data, and output the audio data to user 530 via speaker 515. Computing device 510 may then pause to await receipt of the next voice control command.

In block 5 of operation flow 500, user 530 may speak the command, “back.” Computing device 510 may receive this command via the wireless host, decode the command, and, in response, determine that user 530 has instructed repeat playback of the last step. Accordingly, computing device 510 may retrieve the speech audio data for the previous step (e.g., from Random Access Memory) and output the step (“One tablespoon peanut butter”) to user 530 via speaker 515. Operation flow 500 may continue in this manner until reaching the end of the recipe or until the user stops the program.

FIG. 5B is a block diagram of an example operation flow 550 by which a user 530 controls speech output of text data using continuous control commands. As with operation flow 500 of FIG. 5A, a user 530 utilizing a wireless headset 535 may provide voice commands to computing device 510, which may include an audio output interface 515 (here, a speaker) and a voice input interface 520 (here, a microphone). Furthermore, because the user 530 provides voice commands via a wireless headset 535, computing device 510 may also include a wireless host (not shown).

As described below, operation flow 550 relates to the use of an example set of continuous playback control commands provided via a wireless headset to trigger audio playback of a recipe. It should be apparent that the example operation flow 550 described below is equally applicable to other types of text data, sets of commands, voice input interfaces, and audio output interfaces.

In block 1 of operation flow 500, user 530 may initiate playback of a particular recipe by speaking the command “again.” Upon detection and decoding of this command, computing device 510 may determine that user 530 desires continuous playback of the recipe currently in view. Accordingly, in block 2 of operation flow 500, computing device 510 may convert the first step (“Two slices of bread”) to speech audio data and output the audio data to user 530 via speaker 515. Because user 530 has indicated the desire to use the step-by-step reading method, computing device 510 may retrieve the next step (“One tablespoon peanut butter”) and also output speech audio data for this step to user 530. Computing device 510 may continue this process until receipt of a pause command from user 530.

In block 3, user 530 may direct computing device 510 to pause output by speaking the command, “discontinue.” Accordingly, computing device 510 may halt output of the speech audio data and await receipt of a next command from the user. In block 4, user 530 may direct computing device 510 to continue output of the recipe by issuing the command, “move.”

In block 5, in response to detection and decoding of the “move” command, computing device 510 may resume continuous playback with the next step in the recipe. Accordingly, computing device 510 may retrieve the next ingredient (“One tablespoon jelly”), convert it to speech audio data, and output the speech to user 530 via speaker 515. Because an additional voice command has not been provided in the interim, computing device 510 may continue to block 6, where it may retrieve and convert the directions for the recipe. In particular, computing device 510 may begin output with the first step of the recipe, “Spread peanut butter on one slice.” Operation flow 550 may continue in this manner until all steps have been outputted or until user 530 provides an additional “discontinue” command.

According to the foregoing, example embodiments relate to audio output of text data based on speech control commands provided by a user. In particular, a user may use the speech control commands to control audio output of text data that is converted to speech. More specifically, by issuing voice commands to the computing device, the user may control playback of the speech and, in some embodiments, may use multiple playback methods depending on the available commands. By utilizing the disclosed embodiments, a user may, among other benefits, obtain hands-free access to text data accessible on the computing device, even when located remotely from the device.

We claim:

1. A computing device comprising:
a processor;
a voice input interface;
an audio output interface; and
a machine-readable storage medium encoded with instructions executable by the processor, the machine-readable storage medium comprising:
instructions for accessing text data comprising a set of directions for accomplishing a task, the set of directions comprising a plurality of steps,
instructions for auditorily outputting each step in a sequential order by converting the text data to speech audio data and transmitting the speech audio data over the audio output interface, and
instructions for receiving speech control commands via the voice input interface, the speech control commands allowing for voice-directed control of the sequential output of the set of directions included in the text data.

2. The computing device of claim 1, wherein the text data is a recipe and each step is either a particular ingredient included in the recipe or a particular task for following the recipe.

3. The computing device of claim 1, wherein the speech control commands comprise:
a command for starting speech output of only a first step in the set of directions,
a command for starting speech output of a next step in the set of directions, and
a command for repeating speech output of a last-outputted step in the set of directions.

4. The computing device of claim 3, wherein the speech control commands comprise at least one of:
“beginning” as the command for starting speech output of the first step,
“move” as the command for starting speech output of the next step, and
“back” as the command for repeating speech output of the last-outputted step.

5. The computing device of claim 1, wherein the speech control commands comprise:
a command for beginning continuous speech output of the set of directions in a sequential order,
a command for pausing the continuous speech output of the set of directions, and
a command for resuming the continuous speech output of the set of directions after issuing the command for pausing.

6. The computing device of claim 5, wherein the speech control commands comprise at least one of:
“again” as the command for beginning the continuous speech output,
“discontinue” as the command for pausing the continuous speech output, and
“move” as the command for resuming the continuous speech output.

7. A machine-readable storage medium encoded with instructions executable by a processor of a computing device, the machine-readable storage medium comprising:
instructions for accessing text data comprising a set of directions for accomplishing a task, the set of directions comprising a plurality of steps;
instructions for converting each step in the set of directions to speech audio data, the speech audio data comprising a computer-generated reading of the text data;
instructions for decoding speech control commands received via a voice input interface, the speech control commands directing sequential speech output of the steps in the set of directions; and
instructions for sequentially outputting the speech audio data for the steps in the set of directions in accordance with the speech control commands received via the voice input interface.

8. The machine-readable storage medium of claim 7, wherein the speech control commands include at least one of
a first set of control commands for controlling continuous reading of the set of directions, and
a second set of control commands for controlling step-by-step reading of the set of directions.

9. The machine-readable storage medium of claim 7, wherein the speech control commands comprise:
a command for starting speech output of a next step in the set of directions, and
a command for repeating speech output of a last-outputted step in the set of directions.

10. The machine-readable storage medium of claim 7, wherein the speech control commands comprise:
a command for beginning continuous speech output of the set of directions in sequential order,
a command for pausing the continuous speech output of the set of directions, and
a command for resuming the continuous speech output of the set of directions after issuing the command for pausing.

11. The machine-readable storage medium of claim 7, wherein the instructions for converting each step in the set of directions to speech audio data comprise:
instructions for parsing the text data into the plurality of steps prior to converting each step to the speech audio data.

12. The machine-readable storage medium of claim 11, wherein the instructions for parsing divide the text data into steps using at least one of:
an ordering scheme included in the text data,
user-identified breaks in the text data, and
delimiting characters included in the text data.

13. A method for controlling speech output of a set of directions for accomplishing a task, the method comprising:
receiving, in a computing device via a voice interface, a voice command for beginning speech output of a first step in the set of directions for accomplishing the task, the voice command corresponding to a particular method for outputting the set of directions;
converting text of the first step in the set of directions to speech audio data using a text-to-speech engine;
outputting the speech audio data for the first step using an audio output interface;
when the particular method specified by the voice command for beginning the speech output is a continuous reading method, sequentially converting each step to speech audio data and outputting the speech audio data until receipt of a voice command for pausing the speech output or reaching an end of the set of directions; and
when the particular method specified by the voice command for beginning the speech output is a step-by-step reading method, awaiting receipt of a voice command to resume reading prior to reading a next step in the set of directions.

14. The method of claim 13, wherein the voice interface is a Bluetooth host interface in communication with a Bluetooth headset.

15. The method of claim 13, wherein:
the set of directions is a recipe including a listing of ingredients and a task list, wherein each step is either a particular ingredient or a particular task,
the continuous reading method sequentially outputs speech audio data for all ingredients followed by speech audio data for all tasks until receipt of a pause command, and
the step-by-step reading method outputs one step at a time starting with a first ingredient in the listing of ingredients and ending with a last task in the task list.
